(19) United States
(12) Patent Application Publication
(10) Pub. No.: US 2025/0282290 A1
(43) Pub. Date: Sep. 11, 2025

(54) SYSTEMS AND METHODS FOR ADDING DYNAMIC FIELD OF VIEW AND VIRTUAL DEPTH TO 2-DIMENSIONAL DIGITAL REAR-VIEW MIRRORS

(71) Applicants: Hyundai Motor Company, Seoul (KR); Kia Corporation, Seoul (KR)

(72) Inventors: Yacer Mirza, Superior Township, MI (US); Ryan Dale SonServacio, Superior Township, MI (US); Tuncer Yumak, Taylor, MI (US); Ilyaas Vaid, Superior Township, MI (US)

(21) Appl. No.: 18/599,973

(22) Filed: Mar. 8, 2024

(51) Int. Cl. B60R 1/26; B60R 1/12; G02B 27/00; G02B 27/01

(52) U.S. Cl. CPC B60R 1/26; G02B 27/0093; B60R 2001/1253; B60R 2300/205; G02B 2027/0123; G02B 2027/0127

(57) ABSTRACT

Systems and methods for adding dynamic field of view (FOV) and virtual depth to 2-dimensional (2D) digital rear-view mirrors (DRVMs) are provided. The system may comprise one or more video capture devices configured to capture a video feed, comprising one or more images, of a rear-view of a vehicle, a head-tracking device configured to detect a head position of a driver, and a computing device configured to determine an FOV of the driver, based on the head position of the driver, process one or more images of the video feed to add depth perception, generating a depth image, and cause the depth image to be displayed onto the rear-view display device, generating a displayed image. The depth image may incorporate depth into the video feed. The system may comprise the rear-view display device, configured to display the displayed image. The displayed image may correspond to the FOV.

### BACKGROUND

### Technical Field

Embodiments of the present disclosure relate to systems and methods for adding dynamic field of view (FOV) and virtual depth to 2-dimensional (2D) digital rear-view mirrors (DRVMs).

### Background

Current digital rear-view mirrors (DRVMs) are configured to display simple 2-dimensional (2D) video of a limited rear-view of the environment of the vehicle. The digital video feed provided by current DRVMs displays a 2D video that appears flat to a user's (e.g., driver, passenger, etc.) eyes and does not provide depth perception like a reflective rear-view mirror. This can be uncomfortable for driver and lead to customer complaints.

Current DRVMs require a driver's eyes to adjust due to missing depth perception and a more limited view of surroundings compared to a reflective mirror. This is unnatural for a lifelong user of mirrors and causes eye strain by requiring a user's eyes to manually refocus to near vision from distance vision. This is because, in part, that people look into mirrors but look at screens, and most drivers are used to having no need to re-focus going from windshield to mirror and back. This refocusing to near vision from distance vision is a common complaint among drivers who are far-sighted, as they often complain that DRVMs are blurry.

Current DRVMs have a wide static field of view (FOV), However, this FOV is still a view that is misaligned with where a driver is, as the driver drives the vehicle. This shift is disorienting. In addition, another complaint is that the view displayed from current DRVMs does not change based on the driver's positioning, which is also different from a traditional reflective mirror.

### SUMMARY

According to an object of the present disclosure, a system for adding dynamic field of view (FOV) and virtual depth to 2-dimensional (2D) digital rear-view mirrors (DRVMs) is provided. The system may comprise one or more video capture devices configured to capture a video feed of a rear-view of a vehicle. The video feed may comprise one or more images. The system may comprise a head-tracking device configured to detect a head position of a driver. The head position of the driver may comprise a position of the head of the driver in relation to a rear-view display device. The system may comprise a computing device, comprising a processor and a memory, configured to determine an FOV of the driver, based on the head position of the driver, process one or more images of the video feed to add depth perception to the one or more images, generating a depth image, and cause the depth image to be displayed onto the rear-view display device, generating a displayed image. The depth image may incorporate depth into the video feed. The system may comprise the rear-view display device, configured to display the displayed image. The displayed image may correspond to the FOV.

According to an exemplary embodiment, the head-tracking device may be configured to determine whether the head position of the driver has changed.

According to an exemplary embodiment, the computing device may be configured, when the head position of the driver has changed, to detect, using the head-tracking device, a new head position of the driver and determine, an updated FOV of the driver, based on the new head position of the driver.

According to an exemplary embodiment, the computing device may be configured to process the one or more images of the video feed to add depth perception to the one or more images, generating an updated depth image. The depth image may incorporate depth into the video feed.

According to an exemplary embodiment, the computing device may be configured to cause the updated depth image to be displayed onto the rear-view display device, generating an updated displayed image. The updated displayed image may correspond to the updated FOV.

According to an exemplary embodiment, the computing device, when the head position of the driver has not changed, may be configured to maintain the POV.

According to an exemplary embodiment, the head-tracking device may be configured to image one or more portions of an interior of the vehicle to detect the driver.

According to an exemplary embodiment, the head-tracking device may be configured to determine whether a head of the driver is visible.

According to an exemplary embodiment, displaying the depth image may comprise cropping the depth image to correspond with the FOV.

According to an exemplary embodiment, the computing device may be configured to crop the depth image.

According to an exemplary embodiment, the one or more video capture devices may comprise a plurality of cameras coupled to a rear of the vehicle.

According to an exemplary embodiment, the head-tracking device may be configured to detect whether a driver is present.

According to an exemplary embodiment, the computing device may be configured to display a 2D image on the rear-view display device when the driver is not present.

According to an exemplary embodiment, the head-tracking device may be coupled to the rear-view display device.

According to an exemplary embodiment, the system may comprise the vehicle.

According to an object of the present disclosure, a method for adding dynamic FOV and virtual depth to 2D DR VMs is provided. The method may comprise capturing, using one or more video capture devices, a video feed of a rear-view from a vehicle. The video feed may comprise one or more images. The method may comprise detecting, using a head-tracking device, a head position of a driver. The head position of the driver may comprise a position of the head of the driver in relation to a rear-view display device. The method may comprise determining, using a computing device, an FOV of the driver, based on the head position of the driver, and processing, using the computing device, the one or more images of the video feed to add depth perception to the one or more images, generating a depth image. The depth image may incorporate depth into the video feed. The method may comprise displaying the depth image onto the rear-view display device, generating a displayed image. The displayed image may correspond to the FOV.

According to an exemplary embodiment, the method may comprise, using the head-tracking device, determining whether the head position of the driver has changed.

According to an exemplary embodiment, the method may comprise, when the head position of the driver has changed, detecting, using the head tracking device, a new head position of the driver and determining, using the computing device, an updated FOV of the driver, based on the new head position of the driver.

According to an exemplary embodiment, the method may comprise processing, using the computing device, the one or more images of the video feed to add depth perception to the one or more images, generating an updated depth image. The updated depth image may incorporates depth into the video feed

According to an exemplary embodiment, the method may comprise displaying the updated depth image onto the rear-view display device, generating an updated displayed image. The updated displayed image may correspond to the updated FOV.

According to an exemplary embodiment, the method may comprise, when the head position of the driver has not changed, maintaining the POV.

According to an exemplary embodiment, the method may comprise imaging, using the head-tracking device, one or more portions of an interior of the vehicle to detect the driver.

According to an exemplary embodiment, the method may comprise, using the head-tracking device, determining whether a head of the driver is visible.

According to an exemplary embodiment, the displaying the depth image may comprise cropping the depth image to correspond with the FOV.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 illustrates an example system for adding dynamic field of view (FOV) and virtual depth to 2-dimensional (2D) digital rear-view mirrors (DRVMs), according to an exemplary embodiment of the present disclosure.

FIG. 2A illustrates a vehicle interior identifying a FOV of a driver, according to an exemplary embodiment of the present disclosure.

FIG. 2B illustrates a vehicle interior identifying a FOV of a driver, according to an exemplary embodiment of the present disclosure.

FIG. 3 illustrates a flow chart of a method for adding dynamic FOV and virtual depth to 2D DRVMs, according to an exemplary embodiment of the present disclosure.

FIG. 4A illustrates a rear-view from a vehicle, according to an exemplary embodiment of the present disclosure.

FIG. 4B illustrates a rear-view from a vehicle, according to an exemplary embodiment of the present disclosure,

FIG. 5 illustrates an example architecture of a vehicle, according to an exemplary embodiment of the present disclosure,

FIG. 6 illustrates example elements of a computing device, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

According to exemplary embodiments, systems and methods for adding dynamic field of view (FOV) and virtual depth to 2-dimensional (2D) digital rear-view mirrors (DRVMs) are provided. The dynamic field of view and virtual depth improve a driver's use experience of DRVMs to an experience more similar to that of reflective rear-view mirrors, with similar expected performance.

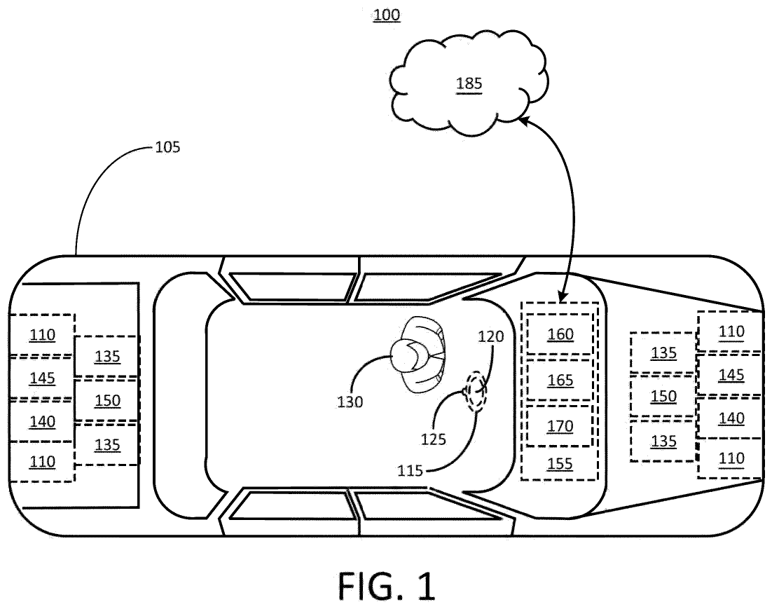

Referring now to FIG. 1, a system 100 for adding dynamic FOV and virtual depth to 2D DRVMs is illustratively depicted, in accordance with an exemplary embodiment of the present disclosure.

According to an exemplary embodiment, the system 100 may be configured to enable a driver to perceive depth in DRVM video and dynamically acquire a wider FOV of a DRVM assembly based on head positioning. According to an exemplary embodiment, the system 100 may comprise a vehicle 105, one or more video capture devices 110 (e.g., one or more cameras and/or other suitable video capture devices) coupled to a rear of the vehicle 105, and/or a rear-view display apparatus 115 comprising a rear-view display 120. According to an exemplary embodiment, the one or more video capture devices 110 may be configured to capture video of an environment behind the vehicle 105 (i.e., a rear view of the vehicle 105).

According to an exemplary embodiment, the system 100 may comprise a head-tracking device 125 configured to track a head of a driver 130 of the vehicle 105. According to an exemplary embodiment, the head-tracking device 125 may be a standalone device, may be coupled to the rear-view display apparatus 115, and/or may be a component of the rear-view display apparatus 115. According to an exemplary embodiment, the head-tracking device 125 may comprise one or more image capturing devices (e.g., cameras) and/or other suitable head-tracking devices.

The vehicle 105 may be an autonomous vehicle (AV), a semi-autonomous vehicle, a manually driven vehicle, and/or other suitable vehicle. According to an exemplary embodiment, the vehicle 105 may comprise one or more sensors such as, for example, one or more audio sensors 135, one or more LiDAR sensors 140, one or more radio detection and ranging (radar) sensors 145, one or more position determining sensors 150 (e.g., one or more Global Positioning System devices), and/or one or more other suitable sensors. According to an exemplary embodiment, the one or more audio sensors 135 may comprise one or more sound sensors, one or more ultrasound sensors, and/or other suitable audio sensors.

According to an exemplary embodiment, the one or more sensors may be in electronic communication with one or more computing devices 155. The one or more computing devices 155 may be separate from one or more of the one or more sensors and/or the rear-view display apparatus 115, may be incorporated into one or more of the one or more sensors and/or the rear-view display apparatus 115, and/or may be coupled to one or more of the one or more sensors and/or the rear-view display apparatus 115.

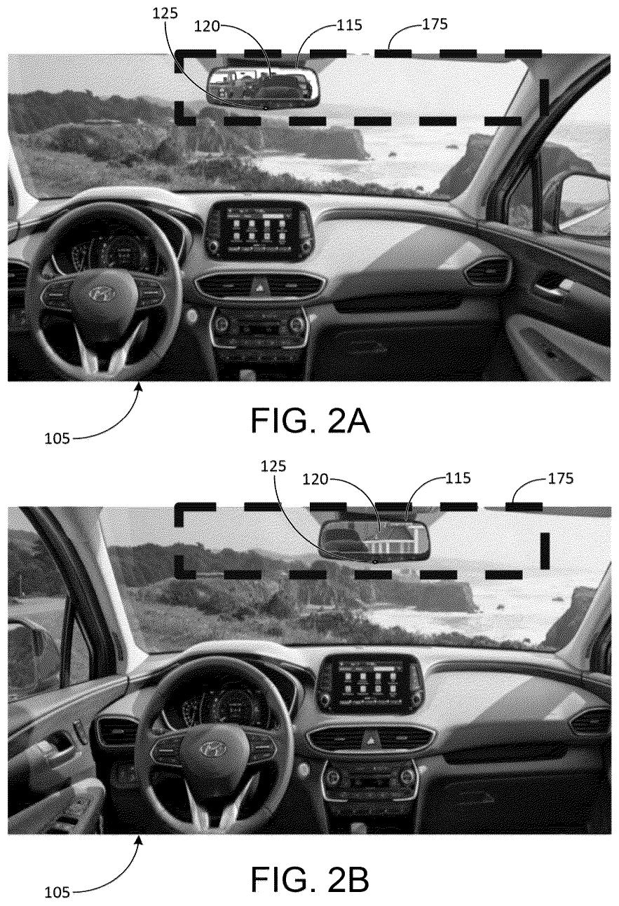

The one or more computing devices 155 may comprise one or more processors 160, memories 165, and/or user interfaces 170 (e.g., graphical user interfaces). The one or more computing devices 155 may be configured to send and/or receive commands/data/etc. via one or more external systems via wired and/or wireless connection (e.g., via the cloud 185). The memory 165 may be configured to store computing instructions that, when executed by the processor 160, are configured to cause the processor 160 to cause the vehicle 105 to analyze data from the one or more video capture devices 110 display virtual depth on the rear-view display 120 of the rear-view display apparatus 115, to analyze data from the head-tracking device 125 to determine a FOV 175 (as shown, e.g., in FIGS. 2A-2B) of the driver 130, to dynamically adjust the video feed on the rear-view display 120 according to a position (e.g., a head position) and FOV 175 of the driver 130, and/or other suitable functions.

According to an exemplary embodiment, an FOV 175 of the driver 130 may change based on the head position of the driver 130. As shown in FIGS. 2A-2B, a rear-view image is displayed on the rear-view display 120 according to a first FOV 175 (FIG. 2A) and, based on a change in head position of the driver 130, a rear-view image is displayed on the rear-view display 120 according to a second FOV 175 (FIG. 2B), According to an exemplary embodiment, the rear-view display apparatus 115 may be configured to dynamically change the image displayed on the rear-view display 120 based on a change in FOV 175.

According to an exemplary embodiment, the rear-view display apparatus 115 may be configured to add depth perception to the rear-view display 120. The depth perception enables the rear-view display 120 to appear, to the driver 130, closer to a tradition rear-view mirror, and decreases the change in focus necessary when changing between looking in front of the vehicle 105 and looking at the rear-view display 120.

According to an exemplary embodiment, the rear-view display apparatus 115 and/or the computing device 155 may be configured to utilize one or more methods for adding depth perception to video on a flat screen (e.g., the rear-view display 120).

For example, the rear-view display apparatus 115 and/or the computing device 155 may be configured to utilize one or more single-image depth estimation methods in which a neural network may be trained on pairs of images from a camera (e.g., one or more video capture devices 110) and their depth maps. The rear-view display apparatus 115 and/or the computing device 155 may be configured to calculate the disparity between the two images. The depth may be calculated using the value of disparity, given the focal length of the camera and the distance between the two images.

According to an exemplary embodiment, the x-axis value, xₗ, and the y-axis value, yₗ, for the left camera of the one or more video capture devices 110, may be determined, e.g., using Equation 1 and Equation 2, where Z is the depth.

$${x}_{l} = f ( \frac{X}{Z} ) \qquad Equation 1$$

$${y}_{l} = f ( \frac{Y}{Z} ) \qquad Equation 2$$

According to an exemplary embodiment, the x-axis value, xᵣ, and the y-axis value, yᵣ, for the right camera of the one or more video capture devices 110, may be determined, e.g., using Equation 3 and Equation 4, where Tₓ is the baseline translation between the two cameras of the one or more video capture devices 110.

$${x}_{r} = f ( \frac{X - {T}_{x}}{Z} ) \qquad Equation 3$$

$${y}_{r} = f ( \frac{Y}{Z} ) \qquad Equation 4$$

According to an exemplary embodiment, the stereo disparity, d, may be calculated using, e.g., Equation 5.

$$d = {x}_{l} - {x}_{r} = f ( \frac{X}{Z} ) - ( f ( \frac{X}{Z} ) - f ( \frac{{T}_{x}}{Z} ) ) = \frac{f ( {T}_{x} )}{Z} \qquad Equation 5$$

Using Equation 5, the depth, Z, may be calculated using, e.g., Equation 6.

$$Z = \frac{f ( {T}_{x} )}{d} \qquad Equation 6$$

By way of example, methods for adding depth perception to video on a flat screen (e.g., the rear-view display 120) may comprise utilizing two cameras (e.g., two cameras of the one or more video capture devices 110) separated by a short distance on the rear of the vehicle 105. These two cameras may be configured to capture two images, forming a stereo pair of images. The rear-view display apparatus 115 and/or the computing device 155 may be configured to compute depth information from the stereo pair of images.

According to an exemplary embodiment, using one or more of the above methods and/or one or more other suitable methods, the rear-view display apparatus 115 and/or the computing device 155 may be configured to process one or more incoming video feeds to generate virtual depth data. According to an exemplary embodiment, the rear-view display apparatus 115 and/or the computing device 155 may be configured to provide, from and based on the raw data, virtual depth to the driver 130 and/or other user on the rear-view display 120. According to an exemplary embodiment, the driver 130 may be displayed, on the rear-view display 120, a processed view with accurate depth incorporated into the video feed.

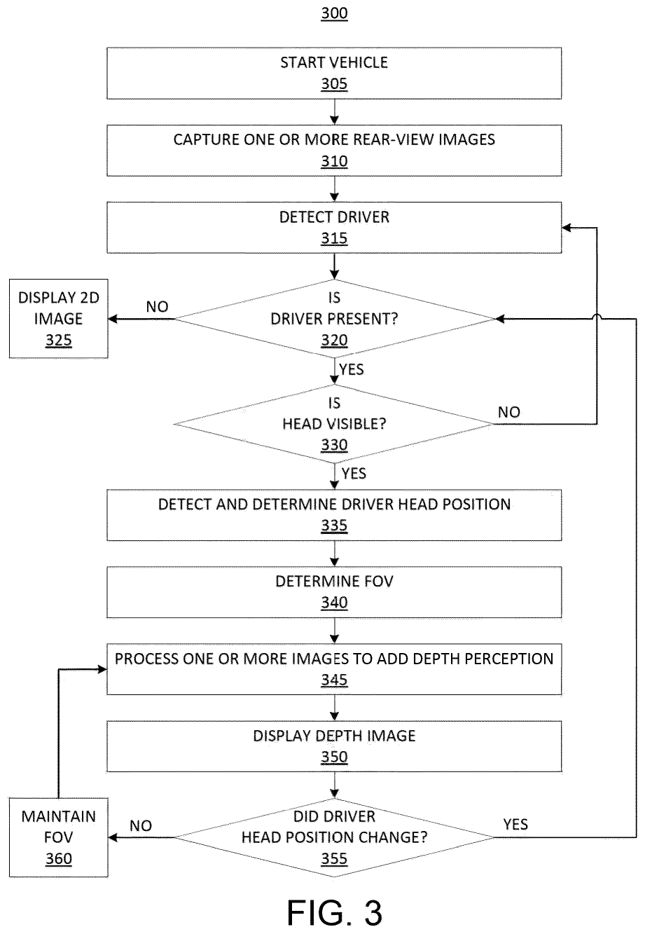

Referring now to FIG. 3, a method 300 for adding dynamic FOV and virtual depth to 2D DRVMs is illustratively depicted, in accordance with an exemplary embodiment of the present disclosure.

At 305, a user may start a vehicle. At 310, one or more images (e.g., a video feed) may be captured of a rear-view from the vehicle. The one or more images may be captured using one or more video capture devices (e.g., one or more cameras). According to an exemplary embodiment, the one or more video capture devices may be coupled to a rear side of the vehicle and/or other suitable location to image a rear-view from the vehicle. According to an exemplary embodiment, the one or more images may be 2D images and/or 3D images of the rear-view from the vehicle.

At 315, the vehicle may be detected for a driver. Driver detection may comprise imaging one or more portions of a vehicle (e.g., an interior of the vehicle) for the presence of the driver. The imaging may be completed using a facial detection system (e.g., a head-tracking device) and/or other suitable imaging sensor.

At 320, it may be determined whether the driver is present. When the driver is not present, then, at 325, a 2D image of the rear-view from the vehicle may be displayed on a rear-view display device of a rear-view display apparatus.

When the driver is present, then, at 330, is may be determined whether the driver's head is visible. Driver head visibility detection may comprise imaging one or more portions of a vehicle (e.g., an interior of the vehicle) for the presence of the driver's head. The imaging may be completed using the facial detection system (e.g., the head-tracking device) and/or other suitable imaging sensor.

When the driver is not visible, then, at 320, it may be determined whether the driver is present. When the driver's head is visible, then, at 335, a driver head position, in relation to the rear-view display device may be detected and determined. According to an exemplary embodiment, determining the driver head position may comprise capturing one or more images of the driver using, e.g., the head-tracking device and/or other suitable imaging device. The head-tracking device may comprise one or more cameras and/or may be coupled to a computing device. According to an exemplary embodiment, determining the driver head position may comprise, using the computing device, analyzing imagery captured by the head-tracking device to determine to determine the driver's head position in relation to the rear-view display device.

At 340, an FOV angle of the driver may be determined, based, e.g., on the driver's head position and/or other suitable factors. According to an exemplary embodiment, facial gaze may not be relevant to FOV angle determination since a traditional mirror changes the FOV based on head position and not facial gaze.

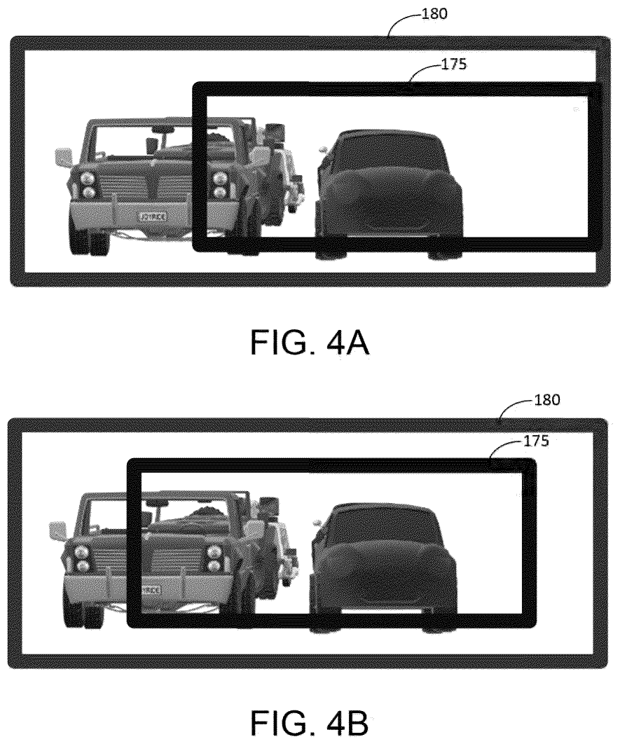

At 345, the one or more images captured of the rear-view from the vehicle may be processed to add depth perception on a flat screen (e.g., the rear-view display device), forming a depth image that incorporates accurate depth into the video feed. At 350, the depth image may be displayed onto the rear-view display device, generating a displayed image that corresponds to the FOV and incorporates the accurate depth into the video feed. According to an exemplary embodiment, displaying the depth image corresponding to the FOV may comprise cropping a full video frame of a rear-view captured by the one or more video capture devices. For example, as shown in FIG. 4A, a full video frame 180 may be cropped to a FOV 175 of a driver.

According to an exemplary embodiment, the driver's head position may change over time. At 355, one or more images captured by the head-tracking device may be analyzed to determine whether the driver's head position has changed. According to an exemplary embodiment, to determine whether the driver's head position has changed, a new head position measurement may be determined and compared to the previous (original/initial/first) head position measurement.

According to an exemplary embodiment, when the driver head position has not changed, then, at 360, the FOV may be maintained and, at 345, the one or more images captured of the rear-view from the vehicle may be processed to add depth perception on the flat screen (e.g., the rear-view display device), forming a depth image that incorporates accurate depth into the video feed.

According to an exemplary embodiment, when the new head position of the driver is different from the previous head position of the driver, then, at 320, the process of determining whether the driver is present, determining whether the head is visible, detecting the driver head position to determine the FOV (e.g., a new/updated FOV), processing the one or more images, and displaying the depth image may be repeated such that an updated FOV of the driver, based on the new head position of the driver, may be determined and an updated depth image may be processed and displayed onto the rear-view display, generating an updated displayed image corresponding to the updated FOV. According to an exemplary embodiment, displaying the depth image corresponding to the updated FOV may comprise cropping a full video frame of a rear-view captured by the one or more video capture devices. For example, as shown in FIG. 4B, a full video frame 180 may be cropped to an updated FOV 175 of a driver.

According to an exemplary embodiment, displaying the depth image according to the driver's FOV, and updating the driver's FOV based on the direction that the driver is looking optimizes a driver's viewing of the rear-view image, including, but not limited to, any object present within that rear-view. According to an exemplary embodiment, the systems and methods of the present disclosure may be configured such that the depth image displayed on the rear-view display may be continuously and smoothly adjusted based on changes in the FOV. According to an exemplary embodiment, the changes to the displayed image may be opposite in direction but equal in magnitude to the head movement position/direction of the driver to imitate the behavior of a traditional mirror.

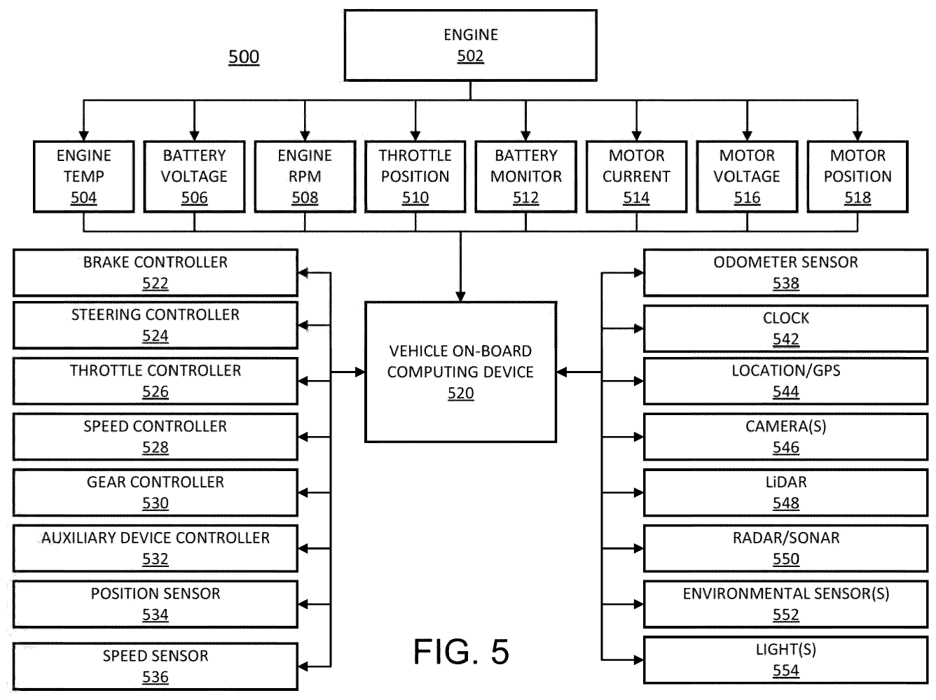

Referring now to FIG. 5, an example vehicle system architecture 500 for a vehicle is provided, in accordance with an exemplary embodiment of the present disclosure. The following discussion of vehicle system architecture 500 is sufficient for understanding one or more components of vehicle 105.

As shown in FIG. 5, the vehicle system architecture 500 may comprise an engine, motor or propulsive device 502 and various sensors 504-518 for measuring various parameters of the vehicle system architecture 500. In gas-powered or hybrid vehicles having a fuel-powered engine, the sensors 504-518 may comprise, for example, an engine temperature sensor 504, a battery voltage sensor 506, an engine Rotations Per Minute (RPM) sensor 508, and/or a throttle position sensor 510. If the vehicle is an electric or hybrid vehicle, then the vehicle may comprise an electric motor, and accordingly may comprise sensors such as a battery monitoring system 512 (to measure current, voltage and/or temperature of the battery), motor current 514 and voltage 516 sensors, and motor position sensors such as resolvers and encoders 518.

Operational parameter sensors that are common to both types of vehicles may comprise, for example: a position sensor 534 such as an accelerometer, gyroscope and/or inertial measurement unit; a speed sensor 536; and/or an odometer sensor 538. The vehicle system architecture 500 also may comprise a clock 542 that the system uses to determine vehicle time and/or date during operation. The clock 542 may be encoded into the vehicle on-board computing device 520, it may be a separate device, or multiple clocks may be available.

The vehicle system architecture 500 also may comprise various sensors that operate to gather information about the environment in which the vehicle is traveling. These sensors may comprise, for example: a location sensor 544 (for example, a Global Positioning System (GPS) device); object detection sensors such as one or more cameras 546; a LIDAR sensor system 548; and/or a radar and/or a sonar system 550. The sensors also may comprise environmental sensors 552 such as, e.g., a humidity sensor, a precipitation sensor, a light sensor, and/or ambient temperature sensor. The object detection sensors may be configured to enable the vehicle system architecture 500 to detect objects that are within a given distance range of the vehicle in any direction, while the environmental sensors 552 may be configured to collect data about environmental conditions within the vehicle's area of travel. According to an exemplary embodiment, the vehicle system architecture 500 may comprise one or more lights 554 (e.g., headlights, flood lights, flashlights, etc.).

During operations, information may be communicated from the sensors to an on-board computing device 520 (e.g., computing device 155, computing device 600), The on-board computing device 520 may be configured to analyze the data captured by the sensors and/or data received from data providers and may be configured to optionally control operations of the vehicle system architecture 500 based on results of the analysis. For example, the on-board computing device 520 may be configured to control: braking via a brake controller 522; direction via a steering controller 524; speed and acceleration via a throttle controller 526 (in a gas-powered vehicle) or a motor speed controller 528 (such as a current level controller in an electric vehicle); a differential gear controller 530 (in vehicles with transmissions); and/or other controllers. The brake controller 522 may comprise a pedal effort sensor, pedal effort sensor, and/or simulator temperature sensor, as described herein.

Geographic location information may be communicated from the location sensor 544 to the on-board computing device 520, which may then access a map of the environment that corresponds to the location information to determine known fixed features of the environment such as streets, buildings, stop signs and/or stop/go signals. Captured images from the cameras 546 and/or object detection information captured from sensors such as LiDAR 548 may be communicated from those sensors to the on-board computing device 520. The object detection information and/or captured images may be processed by the on-board computing device 520 to detect objects in proximity to the vehicle. Any known or to be known technique for making an object detection based on sensor data and/or captured images may be used in the embodiments disclosed in this document.

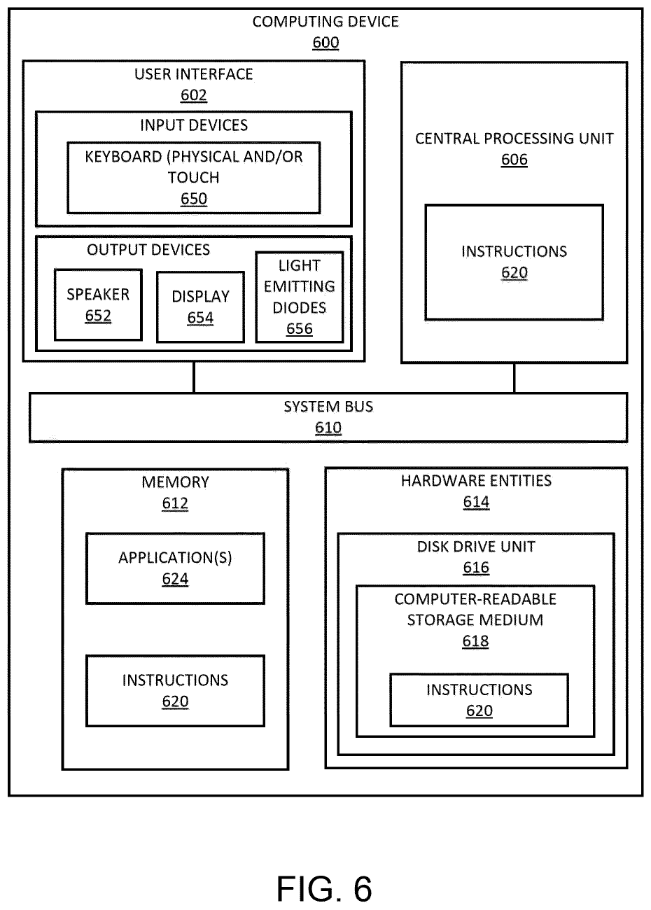

Referring now to FIG. 6, an illustration of an example architecture for a computing device 600 is provided. According to an exemplary embodiment, one or more functions of the present disclosure may be implemented by a computing device such as, e.g., computing device 600 or a computing device similar to computing device 600. Computing device 600 may be a quantum computer, a classical computer, and/or have one or more components configured to perform one or more quantum and/or classical computing functions. Computing device 155 and/or computing device 520 may be an example of computing device 600 and/or may comprise one or more components of computing device 600.

The hardware architecture of FIG. 6 represents one example implementation of a representative computing device configured to implement at least a portion of the systems/devices (e.g., vehicle 105) and method(s)/control logic(s) (e.g., method 300) described herein.

Some or all components of the computing device 600 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 6, the computing device 600 may comprise a user interface 602 (e.g., a graphical user interface), a Central Processing Unit (“CPU”) 606, a system bus 610, a memory 612 connected to and accessible by other portions of computing device 600 through system bus 610, and hardware entities 614 connected to system bus 610. The user interface may comprise input devices and output devices, which may be configured to facilitate user-software interactions for controlling operations of the computing device 600. The input devices may comprise, but are not limited to, a physical and/or touch keyboard 640. The input devices may be connected to the computing device 600 via a wired or wireless connection (e.g., a Bluetooth® connection). The output devices may comprise, but are not limited to, a speaker 642, a display 644, and/or light emitting diodes 646.

At least some of the hardware entities 614 may be configured to perform actions involving access to and use of memory 612, which may be a Random Access Memory (RAM), a disk driver and/or a Compact Disc Read Only Memory (CD-ROM), among other suitable memory types, Hardware entities 614 may comprise a disk drive unit 616 comprising a computer-readable storage medium 618 on which may be stored one or more sets of instructions 620 (e.g., programming instructions such as, but not limited to, software code) configured to implement one or more of the methodologies, procedures, or functions described herein. The instructions 620 may also reside, completely or at least partially, within the memory 612 and/or within the CPU 606 during execution thereof by the computing device 600.

The memory 612 and the CPU 606 may also constitute machine-readable media. The term “machine-readable media”, as used here, refers to a single medium or multiple media (e.g., a centralized or distributed database, and/or associated caches and servers) that store the one or more sets of instructions 620. The term “machine-readable media”, as used here, also refers to any medium that is capable of storing, encoding, or carrying a set of instructions 620 for execution by the computing device 600 and that cause the computing device 600 to perform any one or more of the methodologies of the present disclosure.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A system for adding dynamic field of view (FOV) and virtual depth to 2-dimensional (2D) digital rear-view mirrors (DRVMs), comprising:
one or more video capture devices configured to capture a video feed of a rear-view of a vehicle,
wherein the video feed comprises one or more images;
a head-tracking device configured to detect a head position of a driver,
wherein the head position of the driver comprises a position of the head of the driver in relation to a rear-view display device;
a computing device, comprising a processor and a memory, configured to:
determine an FOV of the driver, based on the head position of the driver;
process one or more images of the video feed to add depth perception to the one or more images, generating a depth image,
wherein the depth image incorporates depth into the video feed; and
cause the depth image to be displayed onto the rear-view display device, generating a displayed image; and
the rear-view display device, configured to display the displayed image,
wherein the displayed image corresponds to the FOV.

2. The system of claim 1, wherein the head-tracking device is further configured to determine whether the head position of the driver has changed.

3. The system of claim 2, wherein the computing device is further configured, when the head position of the driver has changed, to:
detect, using the head-tracking device, a new head position of the driver; and
determine, an updated FOV of the driver, based on the new head position of the driver.

4. The system of claim 1, wherein the computing device is further configured to:
process the one or more images of the video feed to add depth perception to the one or more images, generating an updated depth image,
wherein the depth image incorporates depth into the video feed; and
cause the updated depth image to be displayed onto the rear-view display device, generating an updated displayed image,
wherein the updated displayed image corresponds to the updated FOV.

5. The system of claim 2, wherein the computing device, when the head position of the driver has not changed, is further configured to maintain the POV.

6. The system of claim 1, wherein the head-tracking device is further configured to image one or more portions of an interior of the vehicle to detect the driver.

7. The system of claim 1, wherein the head-tracking device is further configured to determine whether a head of the driver is visible.

8. The system of claim 1, wherein:
displaying the depth image comprises cropping the depth image to correspond with the FOV, and
the computing device is further configured to crop the depth image.

9. The system of claim 1, wherein the one or more video capture devices comprises a plurality of cameras coupled to a rear of the vehicle.

10. The system of claim 1, wherein:
the head-tracking device is further configured to detect whether a driver is present, and
the computing device is further configured to display a 2D image on the rear-view display device when the driver is not present.

11. The system of claim 1, wherein the head-tracking device is coupled to the rear-view display device.

12. The system of claim 1, further comprising the vehicle.

13. A method for adding dynamic field of view (FOV) and virtual depth to 2-dimensional (2D) digital rear-view mirrors (DRVMs), comprising:
capturing, using one or more video capture devices, a video feed of a rear-view from a vehicle,
wherein the video feed comprises one or more images;
detecting, using a head-tracking device, a head position of a driver,
wherein the head position of the driver comprises a position of the head of the driver in relation to a rear-view display device;
determining, using a computing device, an FOV of the driver, based on the head position of the driver;
processing, using the computing device, the one or more images of the video feed to add depth perception to the one or more images, generating a depth image,
wherein the depth image incorporates depth into the video feed; and
displaying the depth image onto the rear-view display device, generating a displayed image,
wherein the displayed image corresponds to the FOV.

14. The method of claim 13, further comprising, using the head-tracking device, determining whether the head position of the driver has changed.

15. The method of claim 14, further comprising, when the head position of the driver has changed:
detecting, using the head-tracking device, a new head position of the driver; and
determining, using the computing device, an updated FOV of the driver, based on the new head position of the driver.

16. The method of claim 15, further comprising:
processing, using the computing device, the one or more images of the video feed to add depth perception to the one or more images, generating an updated depth image,
wherein the updated depth image incorporates depth into the video feed; and
displaying the updated depth image onto the rear-view display device, generating an updated displayed image,
wherein the updated displayed image corresponds to the updated FOV.

17. The method of claim 14, further comprising, when the head position of the driver has not changed, maintaining the POV.

18. The method of claim 13, further comprising imaging, using the head-tracking device, one or more portions of an interior of the vehicle to detect the driver.

19. The method of claim 13, further comprising, using the head-tracking device, determining whether a head of the driver is visible.

20. The method of claim 13, wherein displaying the depth image comprises cropping the depth image to correspond with the FOV.
